(19) United States
(12) Patent Application Publication
(10) Pub. No.: US 2014/0059931 A1
(43) Pub. Date: Mar. 6, 2014

(54) VARIABLE WINDOW SHUTTER SYSTEMS AND METHODS

(71) Applicants: Leonid J. Tasheiko, Santa Rosa Beach, FL (US); Frank J. Eiter, Morganfield, KY (US)

(72) Inventors: Leonid J. Tasheiko, Santa Rosa Beach, FL (US); Frank J. Eiter, Morganfield, KY (US)

(21) Appl. No.: 13/916,108

(22) Filed: Jun. 12, 2013

Related U.S. Application Data
(60) Provisional application No. 61/696,918, filed on Sep. 5, 2012.

(51) Int. Cl. E06B 7/096

(52) U.S. Cl. CPC E06B 7/096
USPC 49/82.1; 49/348

(57) ABSTRACT

A variable window shutter system for attachment to a building including a casing, a frame configured to house one or more louvers, a drive mechanism and gear box configured to move the angle of the louvers that in turn adjusts the amount of light entering the variable window shutter system. The angle of the louvers may be adjusted using a crank handle or a motorized mechanism. The frame may open while being rotatably attached to the casing and kept in an open position using stay bars.

### RELATED CASE INFORMATION

The present application claims benefit of U.S. Provisional Application No. 61/696,918 filed Sep. 5, 2012 and is incorporated herein in its entirety.

### FIELD

The present disclosure relates to a window shutter system and more particularly to a window shutter system having adjustable louvers.

### BACKGROUND

Designers of window shutter systems have many considerations in providing a certain style of exterior window covering. Specifically, there may be particular functional requirements to the window shutter system in addition to consideration of the shutter's aesthetic qualities. These requirements may include the ability to close down the shutter, vary the amount of sun rays entering the shutter, vary the amount of ambient light permitted through the shutter, and protect the window and the occupants of a building structure during times of inclement weather.

Existing shutters, including Bermuda style shutters, afford the user the ability to either open the shutter to a prescribed angle away from the building structure or to close the shutter by pulling and securing to the building structure. In either position, the louvers remain at the same open angle and fixed position. Consequently, there is a need for varying the amount of light and sun rays permitted to pass through the shutter system as well as protecting the window and occupants from the effects of inclement weather.

### SUMMARY

In an illustrative embodiment, a window shutter system including a casing, one or more louvers, a frame, a drive mechanism, and a gear box is disclosed. The frame may be configured to house the louvers and be attached to said casing. The frame may be configured to move in a rotatable manner between an open position and a closed position. The drive mechanism may be configured to adjust the angle of the louvers between an open position and a closed position. The gear box may be configured to move the drive mechanism.

In an illustrative embodiment, a window shutter system for installation into an existing window well is disclosed. This exemplary window shutter system may include a window well casing, a shutter casing, one or more louvers, a frame, a drive mechanism, and a gear box. The window well casing may be configured to set into the existing window well of a building structure. The shutter casing may be configured to attach to the window well casing. The frame may include an attachment mechanism for removable attachment to the shutter casing. The frame may be configured to house the louvers and move in a rotatable manner between an open position and a closed position while the attachment mechanism is engaged with the shutter casing. The drive mechanism may be configured to adjust the angle of one of more louvers between an open position and a closed position. The gear box may include one or more gears that may be configured to move the drive mechanism through rotation of the gears.

In an illustrative embodiment, a window shutter system including means for attachment to a window well, means for housing one or more louvers, means for attaching housing means to the attachment means, and means for adjusting the angle of the one or more louvers is disclosed. The means for attaching housing means to attachment means may be configured to allow for rotatable movement of housing means between an open position to a closed position.

### DESCRIPTION OF DRAWINGS

FIG. 1 illustrates an exemplary embodiment of a window shutter system with adjustable louvers;

FIG. 2 illustrates an exemplary embodiment of a window shutter system with adjustable louvers;

FIG. 3A illustrates exemplary louvers, gear box, and drive mechanism;

FIG. 3B illustrates an exemplary front of a shutter frame;

FIG. 3C illustrates an exemplary back of a shutter frame;

FIG. 3D illustrates an exemplary shutter casing;

FIG. 4 illustrates an exemplary gear box and drive mechanism;

FIG. 5 illustrates an exemplary gear box and drive mechanism;

FIG. 6 illustrates an exemplary gear box;

FIG. 7 illustrates an exemplary drive arm mechanism;

FIG. 8A illustrates exemplary gear box, drive mechanism, and louvers;

FIG. 8B illustrates exemplary gear box, drive mechanism, and louvers;

FIG. 8C illustrates exemplary gear box, drive mechanism, and louvers;

FIG. 9 illustrates an exemplary window shutter system; and

FIG. 10 illustrates an exemplary window shutter system.

### DESCRIPTION

Detailed embodiments of systems and methods for window shutter systems are disclosed herein, however, it is to be understood that the disclosed embodiments are merely exemplary of the window shutter systems, which may be embodied in many forms. Therefore, specific functional details disclosed herein are not to be interpreted as limiting, but merely as a basis for the claims and as a representative basis for teaching one skilled in the art to variously employ the systems and methods disclosed herein.

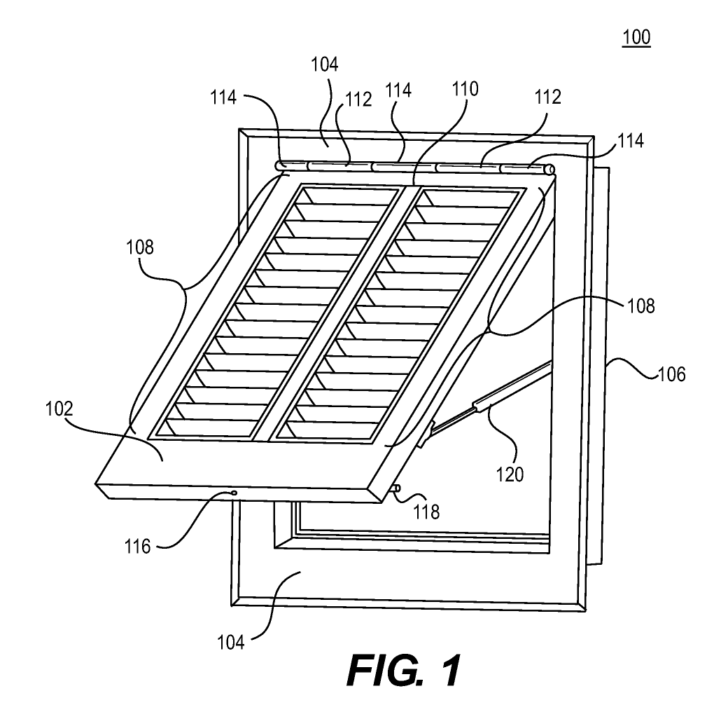

FIG. 1 illustrates a window shutter system 100 including a frame 102, a shutter casing 104, a window well casing 106, louvers 108, a front stile cover 110, hinges 112 and 114, a weep hole 116, a bolt 118, and a bar 120.

A user of window shutter system 100 may open frame 102 as shown in FIG. 1. In FIG. 1, louvers 108 are also shown in an open position. Frame 102 may be configured to engage or communicate with shutter casing 104 via hinges 112 and 114. Hinge 112 may be a male hinge that is disposed on casing 104. Hinge 114 may be a female hinge that is disposed on frame 102. Hinges 112 and 114 may engage so that they attach together to allow rotational movement. Hinges 112 and 114 may form an attachment mechanism to allow frame 102 to be attached to shutter casing 104 while allowing frame 102 to swing to an open and close position. Hinges 112 and 114 may be any type of hinge that accomplishes this operation, including a piano-type of hinge.

Shutter casing 104 may engage with window well casing 106. Window well casing 106 may be configured to be disposed in existing window wells of a building structure. In an exemplary embodiment, casing 104 may be configured such that it conforms to standard window sill configurations.

FIG. 1 depicts window shutter system 100 in an open position with frame 102 positioned away from shutter casing 104. This may be accomplished by using bar 120. Bar 120 may be a spring, such as a hydraulic or gas spring, that positions or sets frame 102 away from shutter casing 104.

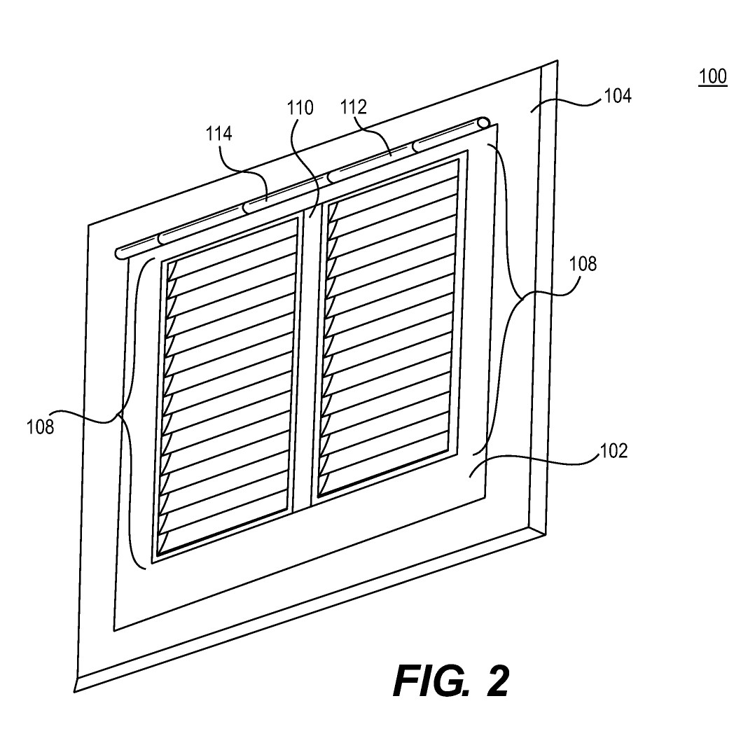

Window shutter system 100 may contain weep hole 116 so that water may flow away from frame 102 and system 100. Window shutter system 100 may also contain bolt 118 to secure frame 102 to shutter casing 104 and allow a user to lock the frame in place. FIG. 2, for example, illustrates frame 102 in a closed position wherein bolt 118 may be used to lock the frame in place.

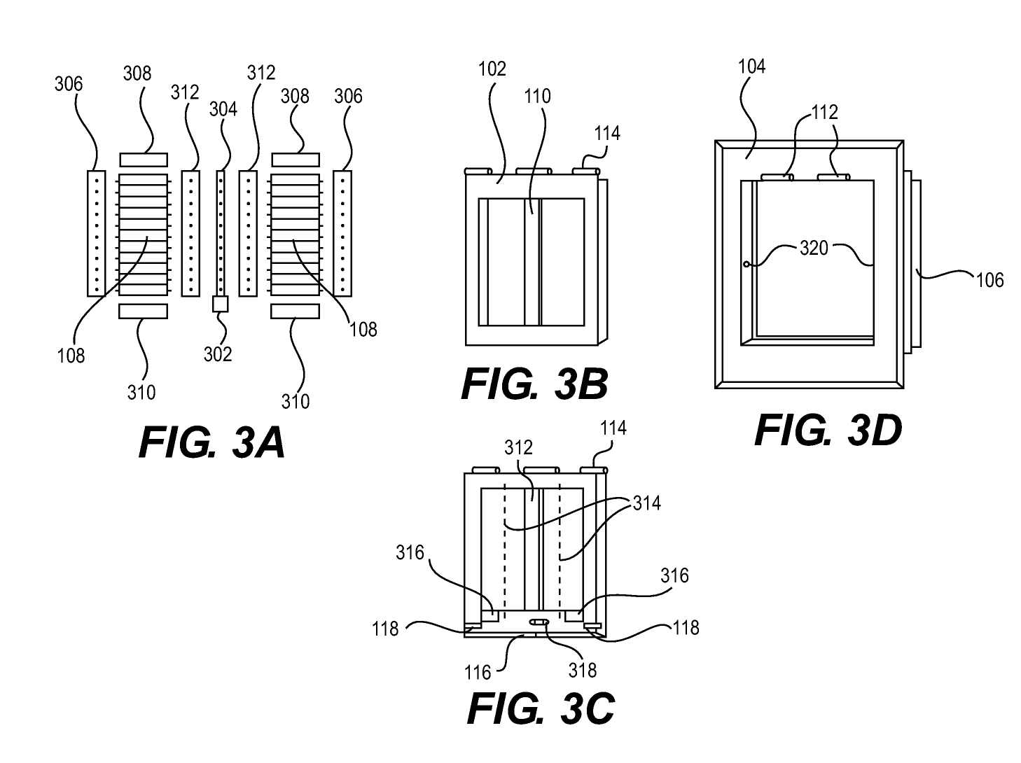

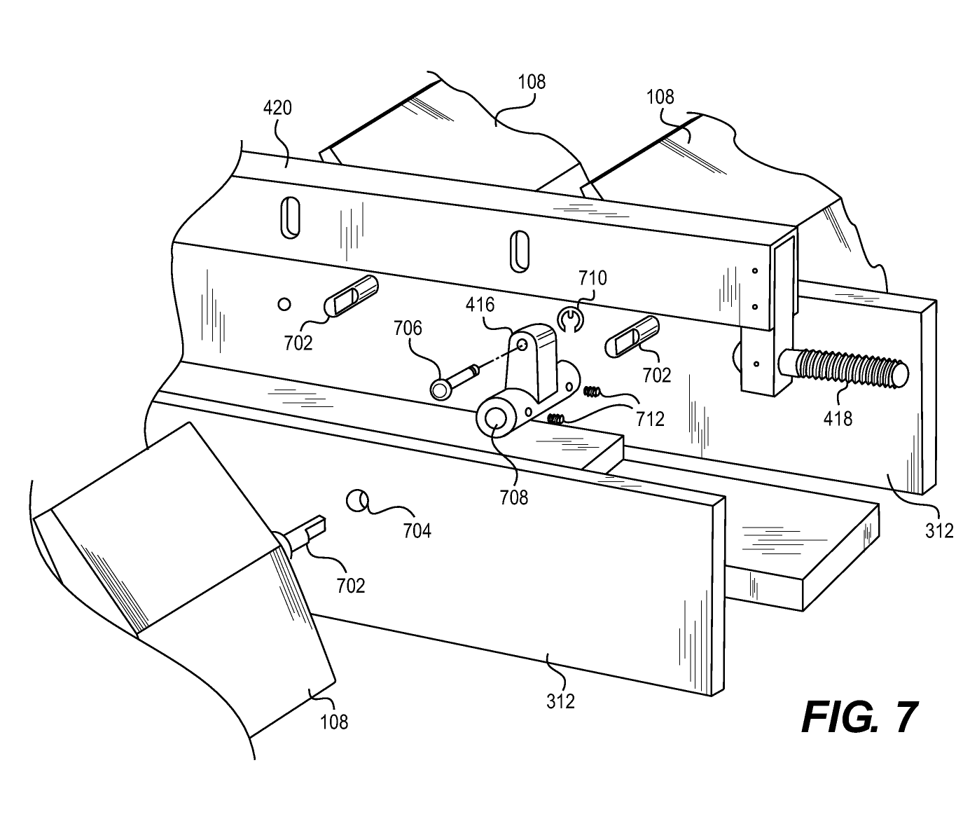

FIG. 3A depicts louvers 108, gear box 302, and drive mechanism 304. Louvers 108 may contain outer sidewall 306, louver head piece 308, louver lintel 310, and inner louver sidewall 312. Louvers 108 may configured to move in a synchronized manner to open and close. Louvers 108 may be moved by operation of gear box 302 and drive mechanism 304 working in tandem to engage louvers 108 (e.g., via pins 702 depicted in FIG. 7 explained in further detail below). The operation of gear box 302 and drive mechanism 304 is explained in greater detail below.

Inner louver sidewall 312 and outer louver sidewall 306 are disposed on opposing sides of louvers 108 in order to create a predetermined spacing between louvers 108. Louver head piece 308 may be disposed above louvers 108. Louver head piece 308 may be configured to act as an anchor or structural backstop for the top of louvers 108. Louver lintel 310 may be disposed below louvers 108. Louver lintel 310 may be configured to act as structural backstop or a base for louvers 108.

FIG. 3B depicts the front of shutter frame 102. The front of shutter frame 102 may have front stile cover 110. The top of shutter frame 102 may contain hinge 114. Front stile cover 110 may be disposed in the center of the opening created by shutter frame 102. Front stile cover 102 may generally be an encasement for drive mechanism 304 to keep exposure of the weather away from drive mechanism 304 and connections between drive mechanism 302 and louvers 108. Front stile cover 102 may also add to the overall strength of the louver section. For example, front stile cover 102 may decrease the length of each individual louver 108. This may add strength to louvers 108 which may improve performance of louvers 108 in inclement and harsh weather conditions. While FIG. 3B depicts front stile cover 102, those of skill in the art would appreciate that a single set of louvers, with or without a stile cover, may be used and be consistent with the present disclosure. Moreover, multiple sets of louvers greater than two, may be used and be consistent with the present disclosure.

Hinge 114 may engage with hinge 112 (shown in FIG. 3D) in order to attach shutter frame 102 to shutter casing 104. This nature of this attachment may allow frame 102 to swing open while being attached to shutter casing 104. While the present disclosure illustrates hinges 112 and 114, other types of hinge assemblies and fasteners known in the art may be used without departing from the present disclosure. Stay bar 120 (shown in FIG. 1) may be provided to set frame 102 in the open position as shown in FIG. 1.

FIG. 3C depicts the back of shutter frame 102. FIG. 3C illustrates hinge 114, weep hole 116, bolts 118, a back stile cover 312, storm bars 314, pull handles 316, and crank handle 318.

Bolts 118 may be disposed on shutter frame 102 in an area that allows a user to lock or fix shutter frame 102 in a closed position and to prevent shutter frame 102 from moving to an open position. Bolts 118 are depicted as slide bolts. Those of skill in the art would appreciate that other types of locks, bolts, or mechanisms may be used in order to lock or fix shutter frame at the closed position.

Back stile cover 312 may be disposed on the back of shutter frame 102 in a position corresponding to front stile cover 110 on the front of shutter frame 102. Back stile cover 312 may be disposed in order to protect drive mechanism 304 and certain connections with louvers 108 from being exposed to the weather. It may be configured in connection with front stile cover 102 to be an encasement for drive mechanism 304 which may decrease the length of each individual louver 108 and may improve performance of louvers 108 in inclement and harsh weather conditions. While FIG. 3C depicts back stile cover 312, those of skill in the art would appreciate that a single set of louvers, with or without a stile cover, may be used and be consistent with the present disclosure. Moreover, multiple sets of louvers greater than two, may be used and be consistent with the present disclosure.

The back of shutter frame 102 may also have storm bars 314. Storm bars 314 may be disposed vertically in relation to louvers 108. Storm bars 314 may provide added strength and protection to louvers 108 when louvers 108 are in a closed position.

Pull handles 316 may be disposed in an area of shutter frame 102 that allows a user to pull shutter frame from the open position (shown in FIG. 1) to the closed position (shown in FIG. 2). Pull handle may be recessed into shutter frame 102.

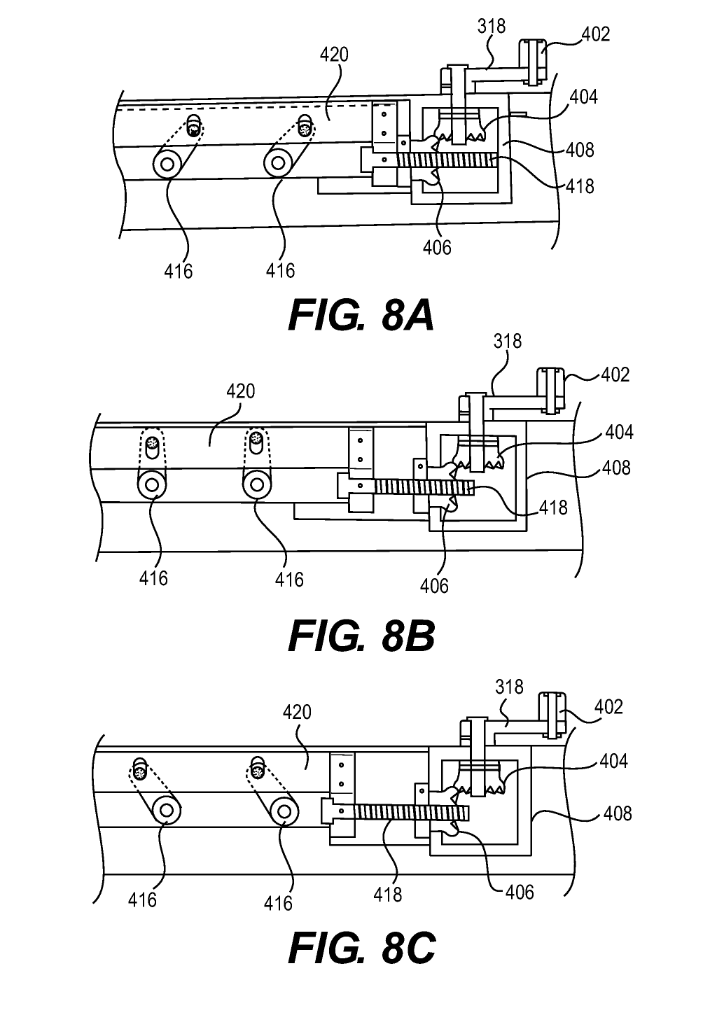

Crank handle 318 may be disposed in an area of shutter frame 102 that allows a user to turn crank handle 318 when it is desired to adjust the angle of louvers 108. Crank handle 318 may allow the user to move louvers 108 to adjust the angle of louvers 108 thereby permitting more or less light to enter shutter system 100 or to close louvers 108 altogether. Movement of louvers 108 is shown in greater detail in FIGS. 8A, 8B, and 8C. Crank handle 318 may be manually operated by a user by turning the handle in a clockwise or counter-clockwise direction or crank handle 318 may be operated via a motorized mechanism that may be configured to adjust the angle of louvers 108.

FIG. 3D depicts shutter casing 104 and window well casing 106. Shutter casing 104 may include hinge 112 and ball joints 320.

Hinge 112 may engage hinge 114 to attach shutter frame 102 to shutter casing 104. Hinges 112 and 114 allow for rotational movement so that shutter frame 102 may swing to an open position and swing back to a closed position.

Shutter frame 102 may stay open via stay bar 120, shown in FIG. 1. Ball joints 320 may engage stay bar 120 (one on each side of casing 104) to allow attachment of stay bar 120 to shutter casing 104.

Window well casing 106 may allow for shutter casing 104 to attach within existing window wells of building structures. This configuration may make installation of the window shutter system 100 easier as existing windows are removed from a building structure and replaced with window shutter system 100 or window shutter systems consistent with embodiments disclosed herein.

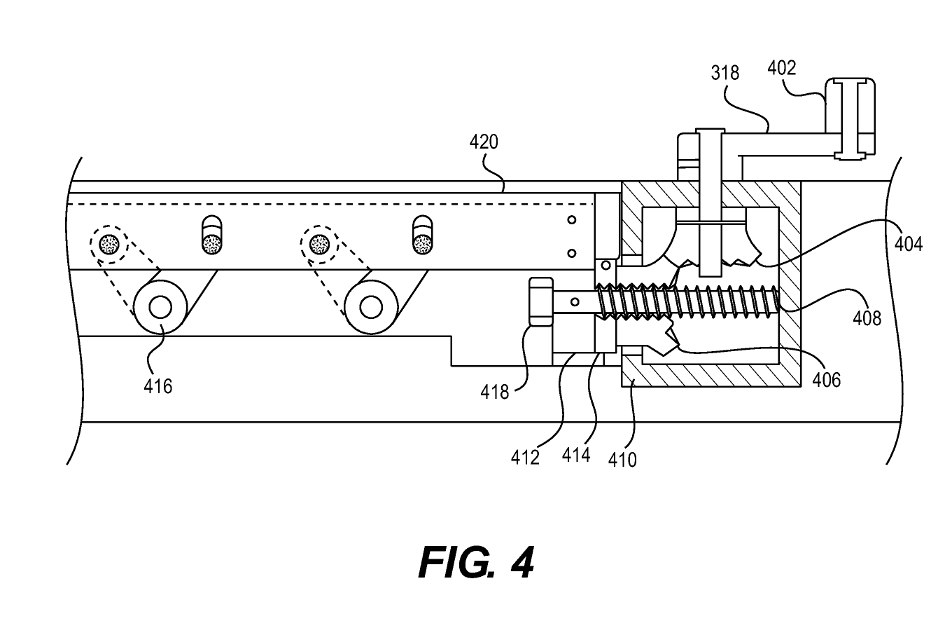

FIG. 4 depicts gear box 302 and drive mechanism 304 in greater detail. Gear box 302 may contain crank handle 318, knob 402, gear 404, gear 406, mechanical stop 408, and containment plate 410. Drive mechanism 304 may contain transfer bar 420, block 412, collar 414, armature 416, and drive rod 418.

Gear box 302 and drive mechanism 304 may be operated in order to adjust the angle of louvers 108. To operate gear box 302 and drive mechanism 304, a user may turn crank handle 318 and knob 402 in a circular motion.

As crank handle 318 rotates, gear 404 also rotates. Crank handle 318 and gear 404 may be attached via a pin connecting these crank handle 318 and gear 404. This attachment and manner of rotation may be accomplished using known means in the art.

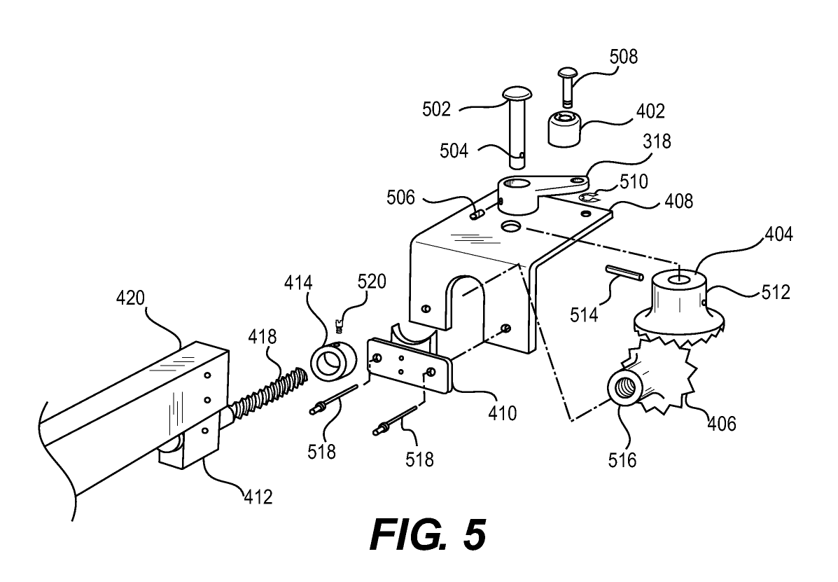

As gear 404 rotates, gear 406 also rotates in response. Gear 404 may communicate with gear 406 wherein gear 406 may be disposed in a perpendicular manner to engage 404 as shown in FIG. 5. As gear 404 turns in a horizontal plane as shown in FIG. 4 (and a vertical plane when window shutter system 100 is installed into a building structure), gear 406 turns in a vertical plane as shown in FIG. 4 (and a horizontal plane when window shutter system 100, for example, is installed into a building structure).

Gear 404 and gear 406 may be disposed within a mechanical stop 408. Mechanical stop 408 may be configured so that crank handle 318 stops when louvers 108 are at a fully open position (see FIG. 8A described in further detail below). In this regard, drive rod 418, which moves laterally in the illustration of FIG. 4 and causes movement of louvers 108 in a manner discussed in greater detail below, contacts mechanical stop 408 and this may prevent crank handle 318 to be moved any further.

Gear box 302 contains containment plate 410 which may attach to mechanical stop 408 in a manner shown in FIG. 5 and sets drive rod 418 to a set position to engage with gear 406 as described in greater detail below.

FIG. 5 depicts gear box 302 and drive mechanism 304 in further detail and includes many of the same elements as described in FIG. 4. In FIG. 5, crank handle 318 may include pin 502, hole 504, and screw 506. Knob 402 may include pin 508 and clip 510. Gear 404 may include hole 512 and pin 514. Gear 406 may include opening 516. Containment plate 410 may include fasteners 518. Collar 414 may include screw 520.

Knob 402 may attach to crank handle 318 by pin 508. Pin 508 may be secured using clip 510. Knob 402 may be secured to crank handle 318 using known means in the art.

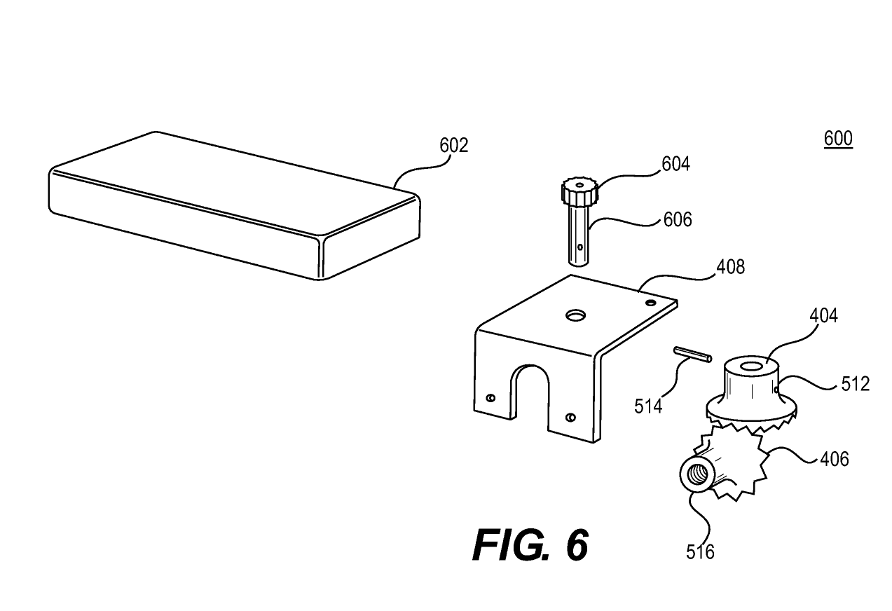

Crank handle 318 may be attached to gear 404 by using pin 502. Pin 502 may be secured by inserting pin 514 through hole 512 and hole 504. Crank handle 318 may be disposed on an upper side of mechanical stop 408 while gear 404 is disposed on an under side of mechanical stop 408. Securing in this manner may allow gear 404 to turn when crank handle 318 is turned by a user. In an alternative embodiment, crank handle 318 may be turned by a motorized mechanism as shown in FIG. 6 (explained in further detail below).

As gear 404 turns it may engage gear 406. Gear 406 may turn in a plane perpendicular to gear 404 as shown in FIG. 5. Opening 516 of gear 406 may be threaded to engage drive rod 418 which may also be threaded. As crank handle 318 is turned, gears 404 and 406 also turn and drive rod 418 may move through gear 406 as the threaded portions of drive rod 418 communicate with threaded portions of opening 516. Drive rod 418 may be attached to transfer bar 420 so that when drive rod 418 moves, transfer bar 420 also moves.

Collar 414 may surround gear 406 and be secured by using screw 520. Containment plate 410 may be secured on one side of collar 414 close to gear 406 and may be attached to mechanical stop 408 using fasteners 518. This may provide additional support so that drive rod 418 engages gear 406 without unduly pivoting which may cause wear and tear of the threaded portions of drive rod 418 and opening 516.

FIG. 6 illustrates a gear box 600, which is an exemplary embodiment and an alternative to gear box 302. Gear box 600 may contain some of the same elements of gear box 302 and may also contain a motor pack 602. Motor pack 602 may engage a drive gear 604 having a hole 606. Drive gear 604 may engage gear 404 when motor pack 602 moves drive gear 604. Drive gear 604 may be secured to gear 404 via pin 514 which is inserted into hole 512 and hole 606. As drive gear 604 rotates, drive rod 418 communicates with gear 406 via opening 516 as previously described. Motor pack 602 may be operated using known power supplies. For example, motor pack 602 may be electrically connected to a battery source or electrical power sources.

FIG. 7 illustrates an embodiment of drive mechanism 304 and louvers 108. FIG. 7 shows three exemplary louvers 108 that may contain pins 702. Each of pins 702 is received into an associated hole 704 of inner sidewall 312.

Armature 416 may also receive pin 702. Armature 416 may be disposed in transfer bar 420 and pin 706 may connect armature 416 to transfer bar 420 via a fastener 710. One side of armature 416 may receive pin 702 through hole 708 as shown in FIG. 7. Louver 108 on the other side of transfer bar 420 may be connected to armature 416 in the opposite side of armature 416 as shown in FIG. 7. Screws 712 may set pins 702 in place within armature 416. Other armatures 416 may receive other louvers 108 in a similar fashion. In operation, as transfer bar 420 moves due to drive rod 418 communicating with gear 406 when crank handle 318 is rotated, louvers 108 twist so that the angle is adjusted. This operation allows a user to open and close louvers 108 and to adjust the level of sunlight passing through louvers 108 or to close louvers 108.

FIGS. 8A, 8B, and 8C illustrate the movement of louvers 108 from a fully open position (FIG. 8A), to a midway position (FIG. 8B), to a fully closed position (FIG. 8C).

In FIG. 8A, drive rod 418 contacts mechanical stop 408 and armatures 416 move louvers 108 (not shown) to an open position.

In FIG. 8B, as crank handle 318 is moved counter-clockwise causing drive rod to move laterally to the left, transfer bar 420 and armatures 416 to move to the left, thus moving louvers 108 to a position that midway between an open and a closed position.

In FIG. 8C, as crank handle 318 is moved further in a counter-clockwise position, drive rod moves further to the left, causing transfer bar 420 and armatures 416 to move to the left, and closing louvers 108.

As noted above, when window shutter system 100 is properly installed and frame 102 is in a closed position, drive rod 418 (which may be threaded) and transfer bar 420 would move up and down, as opposed to laterally as shown in FIGS. 8A-8C.

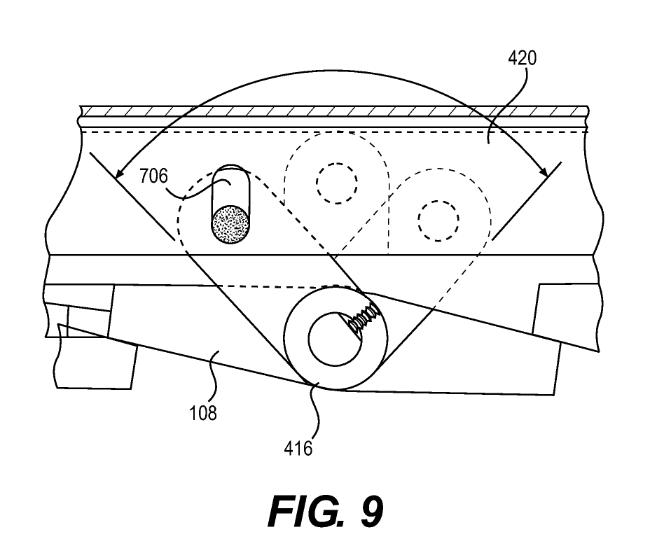

FIG. 9 illustrates an exemplary embodiment of louvers 108, armature 416, and transfer bar 420. In this example, armature 416 is connected to transfer bar 420 by pin 706. As transfer bar 420 moves to the right, the end of armature 416 connected to pin 706 also moves to the right. This movement causes louver 108 to rotate in a manner causing an opening between adjacent louvers 108. As illustrated in FIG. 9, each louver 108 may overlap with adjacent louvers 108. This configuration may add strength to each individual louver and provide greater protection against inclement weather.

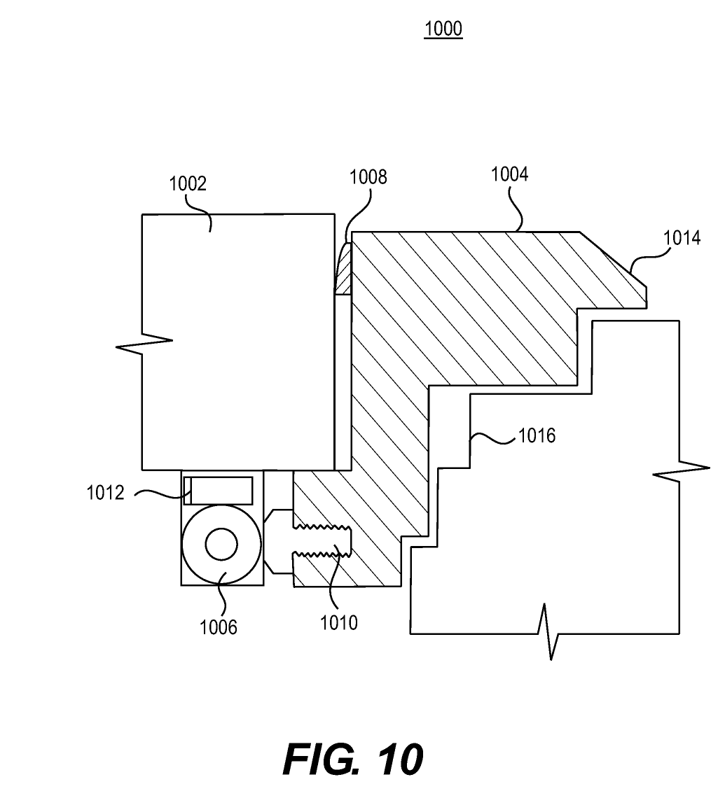

FIG. 10 illustrates an exemplary embodiment of a window shutter system 1000. Window shutter system 1000 may include a frame 1002, a shutter casing 1004, a stay bar 1006, a spacer 1008, a connector 1010, and a bracket 1012. Shutter casing 1004 may include a beveled edge 1014. FIG. 10 also illustrates window casing 1016.

In FIG. 10, shutter casing 1004 may contain a step down configuration which may ensure a conforming fit into window casing 1014. This step down feature may be used to ensure a conforming fit into a standard window casings used by existing buildings.

Beveled edge 1014 of shutter casing 1004 may be configured to be a wind deflector edge. Under this configuration, beveled edge 1014 may act as a deflector for both wind and debris during times of inclement weather.

Stay bar 1006 may be mounted to frame 1002 by using bracket 1012. Frame 1002 may be anchored to shutter casing 1004 by connector 1010. Connector 1010 may be a ball joint type of connector, however, frame 1002 may be anchored to shutter casing 1004 using other means known in the art. Spacer 1008 may also be used between frame 1002 and shutter casing 1004 to create a predetermined space between frame 1002 and shutter casing 1004.

While the systems and methods have been described and illustrated in connection with certain embodiments, many variations and modifications will be evident to those skilled in the art and may be made without departing from the spirit and scope of the disclosure. The systems and methods are thus not to be limited to the precise details of methodology or construction set forth above as such variations and modification are intended to be included within the scope of the disclosure.

1. A window shutter system, comprising:
a casing;
one or more louvers;
a frame configured to house said one more louvers and attached to said casing, said frame configured to move in a rotatable manner between an open position and a closed position;
a drive mechanism configured to adjust the angle of one of more louvers between an open position and a closed position; and
a gear box configured to move the drive mechanism.

2. The system of claim 1, wherein the gear box further comprises:
one or more gears; and
a crank handle configured to communicate with at least one gear to move said drive mechanism.

3. The system of claim 2, wherein said drive mechanism further comprises:
a drive rod configured to communicate with at least one gear.

4. The system of claim 3, wherein said drive mechanism further comprises a transfer bar attached to the drive rod.

5. The system of claim 4, wherein the transfer bar is configured to engage with one or more armatures to move at least one louver.

6. The system of claim 5, wherein each armature is configured to engage at least one louver.

7. The system of claim 1, wherein said frame further comprises a stay bar configured to set said frame in the open position.

8. The system of claim 1, wherein the gear box is motorized and configured to move said drive mechanism.

9. The system of claim 1, further comprising a window well casing configured to receive and attach to said casing.

10. The system of claim 1, wherein said frame further comprises a weep hole.

11. A window shutter system for installation into an existing window well, comprising:
a window well casing configured to set into the existing window well of a building structure;
a shutter casing configured to attach to said window well casing;
one or more louvers;
a frame comprising an attachment mechanism for removable attachment to said casing, said frame configured to house said one more louvers and move in a rotatable manner between an open position and a closed position while the attachment mechanism is engaged with said shutter casing;
a drive mechanism configured to adjust the angle of one of more louvers between an open position and a closed position; and
a gear box, comprising one or more gears, configured to move the drive mechanism through rotation of the one or more gears.

12. The system of claim 11, wherein the gear box further comprises a crank handle configured to communicate with at least one of the one or more gears to move said drive mechanism.

13. The system of claim 12, wherein said drive mechanism further comprises a drive rod configured to communicate with at least one gear.

14. The system of claim 13, wherein said drive mechanism further comprises a transfer bar attached to the drive rod.

15. The system of claim 14, wherein the transfer bar is configured to engage with one or more armatures to move at least one louver.

16. The system of claim 15, wherein each armature is configured to engage at least one louver.

17. The system of claim 16, wherein said frame further comprises a stay bar configured to set said frame in the open position.

18. The system of claim 11, wherein the gear box is motorized and configured to move said drive mechanism.

19. The system of claim 11, wherein said frame further comprises a weep hole.

20. A window shutter system, comprising:
means for housing one or more louvers;
means for attaching housing means to a window well, said means for attaching configured to allow for rotatable movement of housing means between an open position to a closed position; and
means for adjusting the angle of the one or more louvers.
